(19) United States
(12) Patent Application Publication
(10) Pub. No.: US 2025/0121897 A1
(43) Pub. Date: Apr. 17, 2025

(54) SYSTEM AND METHOD OF MODULAR PAYLOAD CONVEYANCE, SPECIALIZED MACHINE AUTOMATION, AND MACHINE TASK MANAGEMENT

(71) Applicant: Brandon Wall, Evans, GA (US)

(72) Inventor: Brandon Wall, Evans, GA (US)

(21) Appl. No.: 18/380,093

(22) Filed: Oct. 13, 2023

Related U.S. Application Data
(60) Provisional application No. 63/371,434, filed on Aug. 15, 2022.

(51) Int. Cl. B62D 63/02; B62D 55/06; B66F 9/065; G05D 1/00

(52) U.S. Cl. CPC B62D 63/025; B62D 55/06; B66F 9/065

(57) ABSTRACT

A comprehensive modular system of payload conveyance, specialized machine automation, and machine task management. The system includes a highly maneuverable modular vehicle platform capable of accommodating an array of interchangeable attachments for performing a variety of machine tasks. The interchangeable attachments adapt the machine for a variety of tasks and can be exchanged using a modular system, which may be remotely controlled, directly controlled, or automated. The modular vehicle platform can interact in plurality deployments of the system as well as interacting with other vehicles, some of which feature alternate modular vehicle platforms. A method for operating the comprehensive modular system.

### CROSS-REFERENCE TO RELATED APPLICATIONS

To the full extent permitted by law, the present United States Non-Provisional patent application hereby claims priority to and the full benefit of, United States Provisional application entitled “PRIMARY POWERED VEHICLE ENABLING THE CONVEYANCE OF SECONDARY VEHICLE(S),” having assigned Ser. No. 63/371,434, filed on Aug. 15, 2022, which is incorporated herein by reference in its entirety.

### BACKGROUND OF THE DISCLOSURE

### Technical Field of the Disclosure

The instant disclosure relates generally to systems and methods for the remotely controlled and/or autonomous control, operation, and movement of heavy objects. Specifically, the disclosure relates to a modular system for the control and movement of heavy machines and objects, including the autonomous and/or remote control thereof.

### Description of the Related Art

Machines are used in various locations in order to move, transport, or otherwise convey various objects thereof. Example locations include warehouses, homes, farms, and other buildings and locations. Many such objects may be heavy, or grouped to become heavy in bulk, and countless adaptations have been made to accommodate objects of various sizes and shapes. These adaptations include lifting and conveying devices, such as forklifts or dollies, grasping and conveying devices, such as crane lifts, and pulling through use of carts and/or hitches to conveyance machines (e.g., truck and trailers). Such machines not only save humans from otherwise exhausting labor, but also make possible the movement of some especially heavy and/or unwieldy objects, which otherwise would not be possible without such machines. Additionally, new developments in remote controls, battery and motor technology improvements, sensors, artificial intelligence, and robotics have produced advanced machines, which may enable certain automated processes in the conveyance of payloads. These machines seek to replace humans in both the industrial environment and a lot of areas of daily life, which may reduce labor costs and improve safety.

Various attempts have been made to alleviate the challenges associated with specialized machine automation and payload conveyance. Some approaches have focused on creating highly specialized machines tailored for specific tasks, aiming to optimize efficiency in individual operations. However, this often results in a proliferation of single-purpose machines, leading to the aforementioned issues of high upfront costs, maintenance complexities, and spatial constraints. Others have explored the integration of advanced robotics and artificial intelligence, seeking to enhance automation capabilities. While promising, these endeavors have encountered limitations in adaptability and versatility, often struggling to address the diverse array of tasks encountered in real-world operational environments. Additionally, certain technologies have sought to employ remote control and autonomous systems, but these solutions have frequently been confined to specific industries or lacked the modular adaptability required to tackle a broad range of tasks effectively.

Although much progress has been made with regard to these technologies, specialization of such machines may require significant upfront expense as well as sufficient expertise and labor to repair, maintain, and otherwise conduct business using them. Additionally, significant, often precious, space and square footage may be consumed by such machines whether or not they are routinely used. In warehouse settings, for instance, some roving automated devices may collect individual objects into another machine featuring racks of bins. Such bins may be deposited onto an automated line, separated into orders, then assembled into shipment containers. Such containers may then be obtained by other roving devices and deposited into vehicles for distribution in a distribution chain/channel. Rarely, in such automated processes, is a single machine responsible for the entire process, and much square footage may be consumed by many specialized machines or even cause congestion/traffic or accidents within such a setting. In fact, using one machine so generalized to complete a simple “pick” from a warehouse may prove inefficient or otherwise impractical. In other situations, such as a home delivery and/or installation, objects may first need to be removed from a home (e.g., HVAC, refrigerator) before the new replacement object can be installed. Given that homes may feature various obstacles and terrains, many times manual machines such as dollies/furniture dollies must be loaded, maneuvered over obstacles, reloaded, and otherwise contorted to meet the demands of a given property and its various, often unexpected, obstacles. Recognizing these challenges, the present disclosure introduces a comprehensive and integrated system that combines the advantages of a versatile machine platform having modular adaptability, advanced automation, and specialized machine task management, offering a groundbreaking solution to the limitations of current technologies.

### SUMMARY

Briefly described, in a possibly preferred embodiment, the present disclosure overcomes the above-mentioned disadvantages and meets the recognized need for such a system and method of modular payload conveyance, specialized machine automation, and machine task management by providing an exemplary remotely-controlled and/or automated modular conveyance capable of receiving specialized equipment for such payload conveyance, a plurality of exemplary specialized heavy equipment modular accessories, and a system for the interoperable and/or automated management/accomplishment of various medium and heavy tasks in various, diverse, adaptable environments. Various embodiments of the disclosure may have specific arrangements, machines, parts, mounts, computers and/or parts thereof, sensors, communication devices, power supplies, the like and/or combinations thereof in order to achieve the intended results as recited herein. Though these specifics may be described to a level of specificity in order to enable those having ordinary skill in the art to practice the disclosed system and method, the disclosure is not so limited to the specific embodiments disclosed herein.

More specifically, the example embodiments of the present system and method of modular payload conveyance, specialized machine automation, and machine task management may include a base conveyance machine capable of receiving, securing, and/or controlling a plurality of modular devices, platforms, machines, and the like. Such a base conveyance machine may be configured to traverse various surfaces via an engine or electrical power (e.g., provided by a rechargeable secondary battery) which may be connected to a motor and/or transmission which may convert machine and/or electrical power to forward/reverse movement via a frictional force. The base conveyance may be directly controlled via a throttle/steering interface as may be found on any known riding vehicles which may be known to those having ordinary skill in the art, such as a steering wheel and a pedal, may be remotely controlled via e.g., radio frequency, BLUETOOTH®, or similar, and/or may be automatically controlled via a networked system having access to a surrounding area sensor information, a camera information, a list of assigned tasks, other data and/or information relevant to the safe and efficient performance of machine-completed tasks, or information that may be obtained by other components of the base conveyance device and/or its modular attachments via a combination of sensors and other onboard information obtaining devices. Automated base conveyances may be adapted to various environments, such as warehouses (where they may interoperate with existing drive-by-wire systems or automated warehouse software platforms), or outdoor work sites (where the base conveyance may be provided with additional traction-control and/or off-roading capabilities and may additionally have access to such information as geographical topography surveys).

In some embodiments, the base conveyance may feature a tire and axel arrangement or in other possibly preferred embodiments, it may instead have a continuous track propulsion system which may be adapted for indoor and outdoor use. Continuous track propulsion systems are commonly featured on various industrial and military-type vehicles, such as tanks and heavy construction equipment, but can also be found on smaller vehicles, such as skid loaders. Unlike wheeled vehicles, which rely on a series of rotating wheels for movement, continuous track vehicles use a system of interconnected, articulated treads that wrap around a set of wheels or sprockets. This design provides a number of advantages, especially in challenging or uneven terrains. Such track systems are generally much less likely to get stuck in soft ground, mud or snow since they distribute the weight of the vehicle over a larger contact area, decreasing its ground pressure. Tracked vehicles also generally feature better mobility over rough terrain than those with wheels, enabling them to smooth out bumps, glide over small obstacles, crossing trenches or breaks in the terrain. Additionally, the larger ground contact area, coupled with treads featuring cleats/grousers, can allow for vastly superior traction that results in a much better ability to push or pull large loads where wheeled vehicles might dig in or cause wheels to spin freely. Tracks of such vehicles having continuous track systems usually cannot be punctured or torn, but should a track be broken, it often can be repaired immediately using only special tools and spare parts. continuous track vehicles generally feature a lower center of gravity compared to wheeled vehicles. Continuous track vehicles may be designed to also feature lower center of gravity than wheeled vehicles. This is due to the distribution of weight over a larger surface area provided by the tracks. In a continuous track vehicle, the weight is distributed along the length of the tracks, which are in contact with the ground. This helps to stabilize the vehicle and reduce the risk of tipping over, especially in uneven or sloped terrain. This enables many designs of continuous track vehicles having heavy components, such as the engine and transmission, lower in the vehicle's chassis and may further contribute to a lower center of gravity, enhancing stability and maneuverability. The lower center of gravity may lend a significant design advantage in scenarios where heavy payloads and/or machinery is affixed, connected to, or otherwise carried by the base modular vehicle, particularly in off-road, uneven, and rugged environments, as its heavy propulsion machinery helps better distribute weight lower (or more evenly) in order to prevent the vehicle from becoming top-heavy and losing stability or tipping, especially during turns or on uneven surfaces. The lower center of gravity also accentuates continuous track vehicles' ability to maintain better traction and control, making those designed with low center of gravity considerations well-suited for tasks that require precision and stability, such as in construction, agriculture, forestry, and military applications.

In an exemplary embodiment, the base conveyance and the propulsion means thereof may be powered in a variety of manners, such as an engine or battery having an external power source for recharging connected to a motor. Electric versions may be preferred in indoor settings. In combination, the compact design, continuous track, battery power, and remotely/autonomously operable features of certain potentially preferred embodiments of the modular base conveyance may achieve a vehicle having an enhanced maneuverability, a reduced environmental (indoor/outdoor) impact, enhanced energy efficiency, improved reliability/reduced maintenance, and rapid acceleration. The incorporation of a battery power and electronic motor system in the modular base conveyance of the disclosure featuring a continuous track vehicle may afford precise control over each track independently. This may enable the modular base conveyance to execute tight turns, pivot on the spot, and navigate through confined spaces with unprecedented agility. The improved maneuverability may further expand the modular base conveyance's applicability in diverse environments, including rugged terrains or even staircases, even while lifting, pulling, or otherwise conveying heavy payloads or when completing specialized tasks. The utilization of a battery power system may significantly mitigate the environmental impact of the modular base conveyance of the disclosure compared to traditional internal combustion engines. By eliminating emissions of harmful pollutants and reducing noise levels, the vehicle aligns with stringent environmental regulations and contributes to a more sustainable and ecologically responsible transportation solution. The integration of a high-capacity rechargeable battery pack, such as a lithium-ion battery, in conjunction with an advanced electronic motor system, optimizes energy utilization. This may result in a vehicle with increased operational range and reduced energy consumption per unit distance traveled and may enable the carrying of heavier payloads. The enhanced energy efficiency can extend the vehicle's operational endurance, making it suitable for extended task assignment lists without frequent refueling or recharging requirements. The electronic motor system may exhibit a higher degree of reliability compared to traditional mechanical power transmission systems, as it involves fewer moving parts and is less susceptible to wear and tear. This translates to a significant reduction in maintenance costs and downtime associated with regular upkeep. Additionally, the absence of complex transmission components enhances the overall robustness and longevity of the vehicle. This arrangement may further enable the instantaneous torque delivery characteristic of electronic motors, providing the continuous track vehicle with exceptional acceleration capabilities. This enables rapid response times, critical for scenarios requiring swift or emergency deployment or for evading sudden obstacles, such as a worker interfering with a planned route. The enhanced acceleration also contributes to improved task-related capabilities and overall task effectiveness. The incorporation of a battery power and electronic motor system further facilitates a modular design approach, allowing for customization based on specific task requirements. The system's scalability permits the integration of varying battery capacities and motor configurations, ensuring adaptability to a wide range of operational scenarios and environments.

In summary, a modular base conveyance of the disclosure having battery power, a continuous track propulsion, a modular accessory system, remote/autonomous control, and an electronic motor system represents a groundbreaking advancement in tracked vehicle technology. This innovative aspect of the overall system of the disclosure combines the proven advantages of continuous track propulsion with the efficiency, environmental responsibility, and operational capabilities afforded by electric power. The result is a vehicle that excels in maneuverability, reliability, energy efficiency, and adaptability, thereby offering a transformative solution for a wide array of applications in the modern transportation, logistic, construction, defense, and other industry and/or business sectors.

A potentially critical additional component of the modular base conveyance may be its capability to receive and interoperate modular accessories. In select embodiments of the modular base conveyance, various connection mechanisms may be provided in order to effectuate a system for modular conveyance and task management using modular accessories. Modular accessories, as they may be understood by those having ordinary skill in the art, may include any number of specialized and/or generalized tools and/or equipment that may be adapted for use with the modular base conveyance. Such adaptation in the imagination of such a skilled artisan may include upscaling or downscaling the size of such equipment as standardly manufactured, increasing, decreasing, and/or redistributing the weight thereof, removing the ordinary means of conveyance, and adapting a connection and interoperability means between the base conveyance and modular accessory. Some of such modular accessories may be detailed and thoroughly described herein, while others may be listed herein or otherwise known and understood by those having skill in the art. Without limitation, they may include hitches, trailer connections, lifts, hand trucks, winches, skid loaders, plows, wagons, the like and/or combinations thereof. Such modular accessories may include a diverse range of modular accessories designed to augment its versatility and functionality. In certain preferred embodiments, these accessories can be engineered for seamless integration with the base vehicle, further expanding its applicability across various industries and applications. For instance, a winch attachment may facilitate the vehicle's capability to perform heavy lifting tasks, enabling it to hoist and transport substantial loads with precision and ease. In another example, a sprayer module may be equipped with a specialized mechanism for the controlled dispensing of liquids or powders, making it suitable for applications such as agricultural spraying, pest control, and environmental remediation and trencher may be engineered for excavating narrow, deep trenches, ideal for applications like utility installations, irrigation systems, and landscaping projects, a snowplow may allow the vehicle to efficiently clear snow and ice from roads, driveways, and pathways. An auger drill head may enable the vehicle to perform precision drilling operations, enabling tasks like fence post installation, tree planting, and soil sampling. A sweeper module may be equipped with a sweeping mechanism, making it suitable for street cleaning, parking lot maintenance, and other surface-cleaning applications, and may include a permanent and/or electromagnet in order to separate and/or collect certain metal from mixed debris. A concrete mixer attachment may be engineered for on-site concrete mixing or a utility toolbox module may provide secure storage and transport for tools and equipment. A mobile generator unit or mobile battery backup module may transform the base conveyance into a mobile power source, capable of supplying electricity for remote work sites, emergency situations, or events. An aerial work platform accessory may allows the vehicle to elevate personnel for tasks such as maintenance, repair, and inspection at elevated heights. These alternate embodiments of the system of the disclosure demonstrate the adaptability and multifunctionality of the base modular conveyance, showcasing its potential to serve as a dynamic and indispensable tool across a wide spectrum of industries and operational contexts. The comprehensive range of modular accessories ensures that the vehicle can be tailored to meet the specific requirements of virtually any task or application and its maneuverability and versatility in this regard may be unmatched, thanks to the improvements as herein disclosed.

In some selected embodiments of the disclosed system, additional modular base vehicles may be provided which may further be configured to receive such modular attachments as may be herein disclosed. Additionally, such additional base modular vehicles may interact with one another and be customized and/or specialized for specific environments which a modular base vehicle of the disclosure may be ill-suited and/or more versatile and expensive than necessary. For instance, a specific alternate modular base is herein disclosed which may feature a four-wheeled, rather than continuous track, drivetrain system. Additional modular bases and other conveyances capable of receiving the modular attachments as disclosed herein may include one-wheeled, two-wheeled, three-wheeled, or other multiple-wheeled vehicles as well as conveyor belts, hovercrafts, marine vehicles (e.g., a boat), conveyances capable of flight (including drones), the like, and/or combinations thereof as may be known to those having ordinary skill in the art. Example uses where, for instance, a four-wheeled modular base may be more economically appropriate include those modular attachments which may function as beach wagons, beverage carts, coolers, refrigerators, freezers, modular grills and other cooking appliances, toolboxes, seating, the like, and/or combinations thereof. Additionally, such alternative bases may include means for connecting to, pulling, pushing, being pulled, being pushed, the like and/or combinations thereof via a hitch or operable connection, which may be capable of controlling the steering, speed, and other movement via mechanical and/or electronic interactions between the various modular bases, or various non-modular base conveyances, such as trailers.

In yet other select embodiments, the vehicles, system(s) and method(s) of modular payload conveyance and task management system of the disclosure may feature remote control and/or autonomous control. The integration of remote and/or autonomous control within a modular vehicle system, comprising a base modular conveyance, a variety of modular accessories, and a control system, may introduce a host of features and benefits that significantly enhance the functionality and versatility of the invention, as may be easily recognized by those having ordinary skill in the art. For instance, the modular base design can allow for the seamless attachment and detachment of a diverse range of accessories, as mentioned above and described in more detail below. This, in conjunction with remote and/or autonomous control, can then offer unparalleled adaptability to suit a multitude of applications, which may be expanded, customized, adapted, improved, and otherwise modified in a dynamically controlled environment. Users can effortlessly configure the vehicle to meet specific task requirements, make their own adaptations for specialized and/or unique uses, and otherwise creatively interact and improve the system. With remote control capabilities, operators can maneuver the vehicle with precision and efficiency, even in challenging or hazardous environments, and can then offload dangerous, cumbersome, or otherwise laborious tasks onto a machine in the user's control. Autonomous control can further streamlines operations by executing pre-programmed tasks, navigating predetermined routes, or developing its own routes via a combination of sensors, cameras, machine learning, and other technologies capable of reducing the need for manual intervention. Remote and autonomous control also may minimize the need for human operators to be physically present in potentially hazardous or inhospitable environments. This feature ensures the safety of personnel by allowing them to operate the vehicle from a distance, mitigating exposure to risks. Remote control functionality embodiments of the machines of the disclosure may further enable operation of the modular base in environments that may be otherwise difficult or dangerous for humans to access. This includes scenarios with limited visibility, extreme temperatures, or exposure to hazardous materials. Remote and/or autonomous control may further offer precise, real-time adjustments to the vehicle's movement, allowing for smooth navigation through confined spaces or intricate tasks. Autonomous control further can also enhance maneuverability by executing complex movements with optimal efficiency, monitoring for changes to environments, and optimizing efficiency via various adjustments to task order. With regard to tasks, the combination of a modular base and a wide array of interchangeable accessories, coupled with remote and/or autonomous control, may enable certain deployments of the system of the disclosure to seamlessly switch between various tasks via either exchange of accessories or deployment of multiple modular bases. This versatility ensures maximum utilization of the vehicle(s) across different industries and operational contexts and may offer the ability to “split shifts” for the modular base in circumstances where one task may be needed during one portion of the day with another task (or multiple other tasks) being critical to other periods of the day. The ability to remotely operate or autonomously control the vehicle may also enhance operational speed and efficiency, resulting in time and cost savings. This is particularly significant in industries where timely execution of tasks is critical. The modular design of the vehicle system of the disclosure, coupled with remote and autonomous control capabilities, may further “future-proof” the technology or the investment in a system of the disclosure. New accessories, devices, parts, and control features can be integrated into the system as technology advances or new tools are developed, ensuring continued relevance and adaptability by providing a modular system for inclusion of these new technologies as they develop. As will be more understood from a further review of the Detailed Description and Drawings, the integration of remote and/or autonomous control with a modular base and a diverse range of accessories represents a significant advancement in vehicle technology. The synergistic combination of these features empowers users with unparalleled customization, operational efficiency, safety, and adaptability across a broad spectrum of industries and applications.

These and other features of the system and method of modular payload conveyance and specialized machine operation/automation will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The system and method of modular payload conveyance will be better understood by reading the Detailed Description with reference to the accompanying drawings, which are not necessarily drawn to scale, and in which like reference numerals denote similar structure and refer to like elements throughout, and in which:

FIG. 1 is a perspective drawing of a modular base conveyance of the disclosure;

FIG. 2 is a top plan drawing thereof;

FIG. 3 is a front elevation closeup cutaway drawing of a portion of the drivetrain thereof;

FIG. 4 is a perspective drawing of one modular accessory of the disclosure;

FIG. 5 is a perspective drawing of the modular accessory combining with the modular base conveyance of the disclosure;

FIG. 6 is a perspective drawing of the modular base conveyance in combination with another modular accessory of the disclosure, the modular accessory having a payload in a carrying position;

FIG. 7 is a perspective drawing of the modular base conveyance in combination with the modular accessory in a depositing position;

FIG. 8 is a perspective drawing of the modular base conveyance in combination with the modular accessory completing the deposit;

FIG. 9 is a perspective drawing of the modular base conveyance in combination with yet another modular accessory of the disclosure, the modular accessory in a lifting position;

FIG. 10 is a perspective drawing of the modular base conveyance in combination with the modular accessory in a carrying position;

FIG. 11 is a perspective drawing of the modular base conveyance of the disclosure in a towing configuration with a trailer;

FIG. 12 is an elevation drawing of the modular base conveyance in combination with one of the modular accessories climbing a staircase;

FIG. 13 is a perspective drawing of the modular base conveyance in combination with a riding modular accessory of the disclosure;

FIG. 14 is a top plan drawing of a room having an exemplary embodiment of the system of the disclosure;

FIG. 15 is a perspective drawing of an alternate embodiment of the modular base vehicle of the disclosure;

FIG. 16 is a flowchart drawing of a method of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

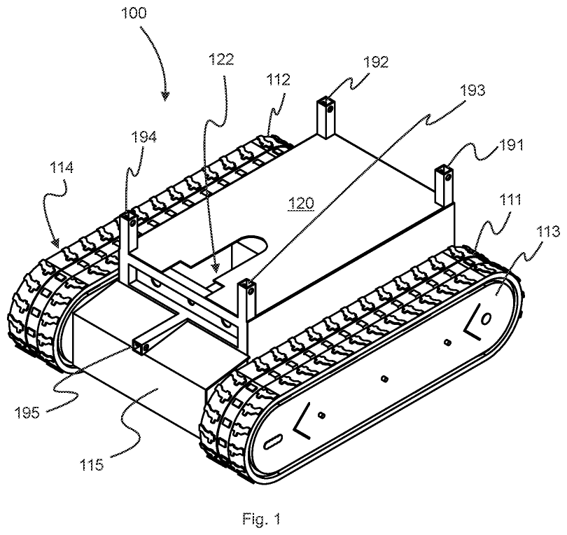

In describing the exemplary embodiments of the present disclosure, as illustrated in FIGS. 1-15, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. It should be noted that the terms vehicle(s) and/or conveyance(s) may be used herein interchangeably as descriptors for any motorized means of conveyance which include a propulsion system which can be controlled by a human or computer. Additionally, the modular base conveyance of the disclosure in its various embodiments as may be disclosed herein may be referred to as simply base 100. The disclosure is not limited to specific configuration of the conveyance or modular accessories and/or features thereof as herein illustrated.

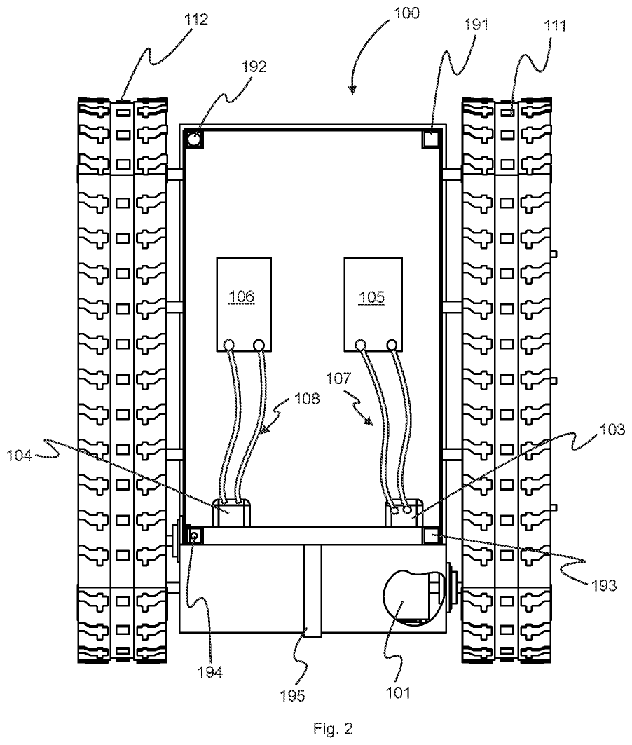

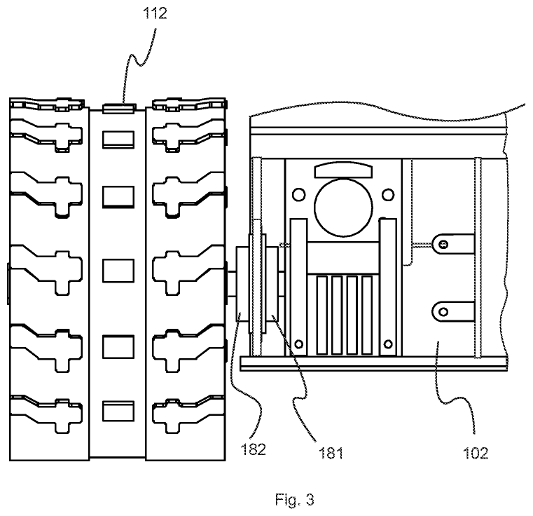

Referring now to FIG. 1 by way of example, and not limitation, therein is illustrated a perspective drawing of an exemplary embodiment of base 100. Generally, base 100, in a potentially preferred embodiment, may feature right tread 111 opposite left tread 112 for propelling base 100 forward and backward. Right tread 111 may be driven in forward and reverse rotation by right drivetrain assembly 101 (see e.g., FIG. 2) which may comprise an independent spinning motor in order to spin right tread 111 about the track thereof. Left tread 112 may be driven in forward and reverse rotation by left drive train assembly 102 (see e.g., FIG. 3) which may comprise an independent spinning motor in order to spin left tread 112 about the track thereof. Internal components of base 100 may be protected by each of right tread guard 113 and left tread guard 114 as illustrated therein FIG. 1. Additionally, in various exemplary embodiments, base 100 may further feature one or more of base hitch 195, connection cavity 122, and base connection posts 191-194 (which may include right front base connection post 191, left front base connection post 192, right rear base connection post 193, and left rear base connection post 194). As may be understood by those having ordinary skill in the art, by providing independently driven motors connected to continuous track systems on each side, base 100 may be highly maneuverable through independent speed of rotation of each track, enabling base 100 to complete very tight turns about corners, rotate in place, and navigate difficult terrain without losing significant traction, thereby increasing the overall mobility of base 10 and any devices, accessories, connections, or payloads thereof. Finally, base 100 may feature the components of protective cover 120 in order to protect and/or cover the internal features thereof base 100 as well as chassis 115 which may be configured to connect and/or assemble the various parts thereof base 100 into a functional conveyance. Protective cover 120 may feature connection cavity 122 in order to accommodate various accessories and/or modular attachments as may be further described below. Further exemplary components, features, and benefits of base 100 may be further understood to those having ordinary skill in the art upon review of the remaining Drawings and Detailed Description.

Turning now to FIG. 2, therein illustrated is a top plan drawing thereof an exemplary base 100 having protective cover 120 removed to reveal exemplary components of base 100. Various features of base 100, including the various parts shown therein FIG. 2, may be secured or otherwise connected/fastened to chassis 115 to form b base 10. About the internal features of base 100 and at its top may be positioned each of base connection posts 191-194, including right front base connection post 191, left front base connection post 192, right rear base connection post 193, and left rear base connection post 194 for connection thereto various modular components which are described in more detail below. Within the cavity therein chassis 115 and among base connection posts 191-194 may reside battery 105 and battery 106 which may be of the secondary, rechargeable variety and may be lithium-ion in certain preferred embodiments, though the disclosure is not so limited. Such cavity may further feature right drive train assembly 101 and left drive train assembly 102 each having connections to and/or inseparable combination therewith right motor 103 and left motor 104, respectively, in order to supply rotational force to each of right tread 111 and left tread 112, also respectively. As illustrated therein FIG. 2, battery 105 and battery 106 may each be connected to right motor 103 and/or right drive train assembly 101 and left motor 104 and/or left drive train assembly 102 via electrical connection 107 and electrical connection 108. Alternatively, base 100 may feature alternative power sources and/or arrangements, including but not limited two single- and multi-battery arrangements having consolidated and/or separate connections thereto each independently driven motor. As illustrated therein FIG. 2, right tread 111 and left tread 112 may be connected to chassis 115 via one or multiple attachments, and may further feature various assemblies and/or sub-assemblies as may be understood by those having ordinary skill in the art, in order to effectuate the electrification of the various motors thereof base 100 to provide rotational and/or other mechanical power in order to propel base 100. Further exemplary components, features, and benefits of base 100, as well as other features as they may be relevant to modular accessories which may interact and/or combine with base 100 may be further understood to those having ordinary skill in the art upon review of the remaining Drawings and Detailed Description.

Turning to FIG. 3, illustrated therein is a front elevation closeup cutaway drawing of a portion of various drivetrain aspects of base 100 in order to highlight certain possibly important features of the components illustrated therein. As may be appreciated by those having ordinary skill in the art, FIG. 3 is a closeup of one side of a two-sided substantially chiral assembly, the redundant opposing drawing of which has been omitted for simplicity. Starting at the center of base 100 and/or right side of FIG. 3, an exemplary embodiment of left drive train assembly 102 is illustrated, which may also feature left motor 104. An axel may extend from left drive train assembly 102 in order for it to transfer its rotational force upon left tread 112 to provide forward/reverse movement thereof. Surrounding such axel may be internal axel support bracket 181 and external axel support bracket 182, which may be opposedly connected thereto a side of base 100 and may provide additional support/structure thereto the assembly formed therefrom, which may prove especially beneficial when performing substantially heavy tasks. Such internal axel support bracket 181 and external axel support bracket 182 may be further connected to each other using, e.g., threaded bolt assemblies or welds, in order to further strengthen the assembly during such tasks and prevent wear. Further exemplary components, features, and benefits of base 100, as well as other features as they may be relevant to modular accessories and heavy tasks may be further understood to those having ordinary skill in the art upon review of the remaining Drawings and Detailed Description.

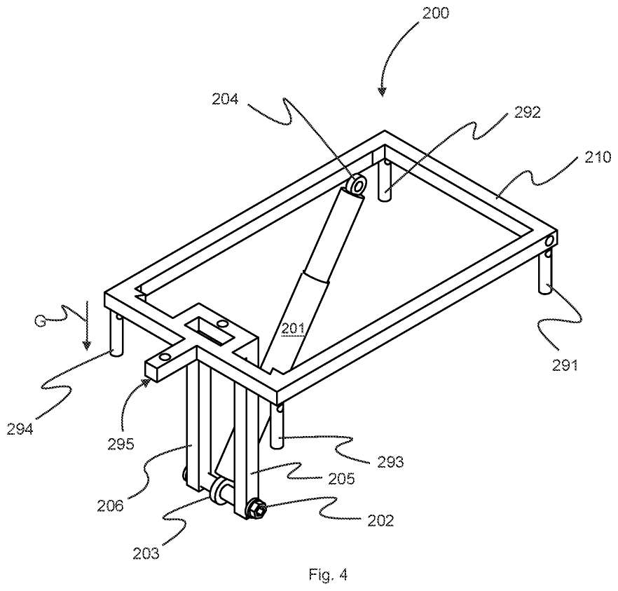

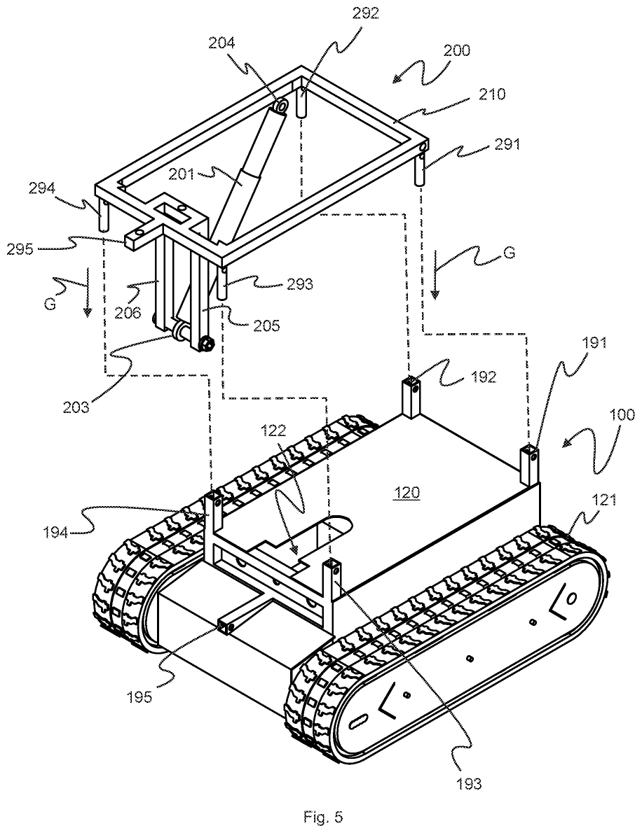

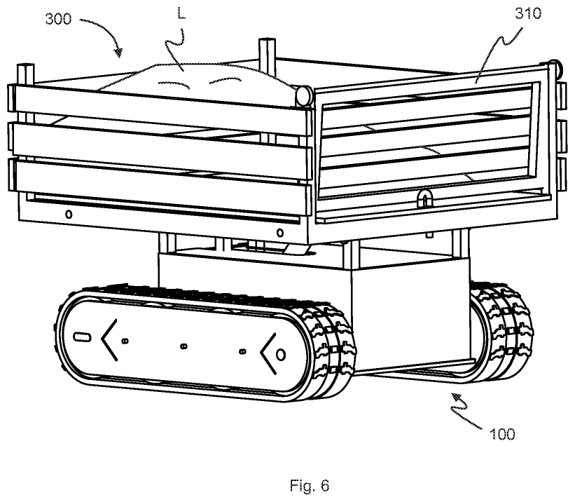

Now turning to FIG. 4, illustrated therein is a perspective drawing of modular lifting platform 200. As it may be important to base 100, modular lifting platform 200 and other various modular accessories of the disclosure, may feature lifting platform connection posts 291-294 (including, e.g., right front lifting platform connection post 291, left front lifting platform connection post 292, right rear lifting platform connection post 293, and left rear lifting platform connection post 294), which may correspond and operably combine with base connection posts 191-194 (see, e.g., FIGS. 5-6). Gravity G is indicated for reference. In such a potentially preferred embodiment of modular lifting platform 200 as may be illustrated in FIG. 4, modular lifting platform 200 may generally comprise a plurality of members spanning from each of the 4 corners formed by lifting platform connection posts 291-294 and connected to each adjacent post, but the disclosure is not so limited. Such members may be understood to form platform 210 Extending downward from platform 210 from one such member may be sub-platform extensions 205-206, which may be configured to extend into connection cavity 122 (see, e.g., FIGS. 1 and 5) when so combined. Therebetween sub-platform extensions 205-206 may be bottom rotational joint 203 of lifting arm 201, and top rotational joint 204 opposite thereof for connection to a secondary modular accessory thereof modular lifting platform 200. Such secondary modular accessories may be hinged to platform 210 in order to tilt such secondary modular accessory upwardly at an end to, for example, deposit and/or dump a payload. Lifting arm 201 may be hydraulic or otherwise powered and/or actuated and may be chosen and/or calibrated to accommodate various loads of various sizes. Finally, modular lifting platform 200 may also feature platform hitch 295, which may provide further modular accessory and/or towing connections thereto base 100 via modular lifting platform 200. Further exemplary components, features, and benefits of modular lifting platform 200, as well as other alternative modular accessories of the disclosure, and their various connection(s) to base 100 as they may be relevant to said modular accessories and corresponding heavy tasks may be further understood to those having ordinary skill in the art upon review of the remaining Drawings and Detailed Description.

As it may relate to FIG. 5, illustrated therein is a perspective drawing of modular lifting platform 200 combining with base 100. As detailed in FIGS. 1-2, base 100 may generally include right tread 111 opposite left tread 112 for propelling base 100 forward and backward. Right tread 111 may be driven in forward and reverse rotation by right drivetrain assembly 101 which may comprise an independent spinning motor in order to spin right tread 111 about the track thereof. Left tread 112 may be driven in forward and reverse rotation by left drive train assembly 102, which may comprise an independent spinning motor in order to spin left tread 112 about the track thereof. Internal components of base 100 may be protected by each of right tread guard 113 and left tread guard 114. Additionally, in various exemplary embodiments, base 100 may further feature one or more of base hitch 195, connection cavity 122, and base connection posts 191-194 It should be evident to those having ordinary skill in the art viewing FIG. 5 that modular lifting platform 200 and other various modular accessories of the disclosure, may feature lifting platform connection posts 291-294 (including, e.g., right front lifting platform connection post 291, left front lifting platform connection post 292, right rear lifting platform connection post 293, and left rear lifting platform connection post 294), which may correspond and operably combine with base connection posts 191-194 as illustrated herein FIG. 5 and indicated by broken lines connecting the respective base connection posts 191-194 to their corresponding lifting platform connection posts 291-294. Further describing those details of modular lifting platform 200 illustrated therein FIG. 5, modular lifting platform 200 may generally include (in addition to lifting platform connection posts 291-294) a plurality of members spanning from each of the 4 corners formed by lifting platform connection posts 291-294 and connected to each adjacent post to form platform 210. Sub-platform extensions 205-206 may extend downwardly from platform 210 in order to extend into connection cavity 122 when so combined. Therebetween sub-platform extensions 205-206 may be bottom rotational joint 203 of lifting arm 201, and top rotational joint 204 opposite thereof for connection to a secondary modular accessory thereof modular lifting platform 200. Connection cavity 122 may be further configured to accept lifting arm 201 and accommodate a rotation thereof. Additional secondary modular accessories may be hinged to platform 210 in order to tilt such secondary modular accessory upwardly at an end to, for example, deposit and/or dump a payload (see, e.g., FIG. 6). As specified above, lifting arm 201 may be hydraulic or otherwise powered and/or actuated and may be chosen and/or calibrated to accommodate various loads of various sizes and may also feature platform hitch 295, which may provide further modular accessory and/or towing connections thereto base 100 via modular lifting platform 200.

In use, modular lifting platform 200 may be placed upon base 100 and connected thereto. In a various embodiments of a system of the disclosure, connection means and/or mechanisms may be provided therebetween modular lifting platform 200 and base 100. For instance, modular lifting platform 200 may have right front lifting platform connection post 291, left front lifting platform connection post 292, right rear lifting platform connection post 293, and left rear lifting platform connection post 294 which may correspond to right front base connection post 191, left front base connection post 192, right rear base connection post 193, and left rear base connection post 194, respectively, thereof base 100. While gravity alone may provide sufficient structure and support to the combined device of base 100 having modular lifting platform 200, the description is not so limited and such structure and support in potentially preferred embodiments may be provided in a variety of ways. In some embodiments, such structural and supportive connections may be detachable. By example and not limitation, these detachable means and mechanisms may include but are not limited to set pins/screws, quick release fasteners, snap fasteners, magnets, magnetic clamps, clips, latches, bayonet mounts (with release mechanisms and/or spring release), threaded connections with knurled nuts, spring-loaded pins, hook and loop fasteners, toggle clamps (with release lever(s), cotter pin(s), quick connect couplings, snap rings, detent pins, push-to-connect fittings, cam locks, slide and lock mechanisms, magnetic quick-connect couplings, bolt(s) and (wing) nut(s), dovetail joints, the like and/or various combinations thereof as may be known to those having ordinary skill in the art. While various tradeoffs may exist as may be anticipated by those having ordinary skill in the art in not providing a detachable connection (i.e., providing a permanent connection), the disclosure is not limited to detachable connections therebetween modular lifting platform 200 and base 100, which may include but are not limited to bolted joint(s), weld(s), riveted joint(s), adhesive bonding, the like, and/or various combinations thereof. Such permanent connections may primarily interfere with the modular features and benefits of various as described herein, but at least in connection with modular lifting platform 200, some modular features and benefits may remain thanks to the top-sided modular features of modular lifting platform 200 as may be herein described. With respect to such additional modular features as they may relate to modular lifting platform 200 in a possibly preferred embodiment, modular lifting platform 200 may connect to a platform, carrier, or machine at top rotational joint 204, which may feature an aperture for insertion of a rod, pin, or other cylindrical mechanical connection to lifting arm 201. When extended, lifting arm 201 may lift such modular accessories and when contracted lifting arm 201 may lower them. In combination, base 100 and modular lifting platform 200 may provide sufficient modular features to accommodate many carrying and placement tasks, as will become evident from a review of these additional aspects. The modular lifting platform 200 represents a pivotal component within the inventive system, characterized by its adaptability and ease of integration.

This versatile platform of both base 100 and modular lifting platform 200 may provide for seamless staging and storage alongside an array of other modular attachments within a work site or warehouse environment. The compact form factor and standardized connection points may ensure efficient utilization of available space, allowing multiple attachments to be conveniently arranged for accessibility. Modular lifting platform 200 may be strategically positioned within the designated area, which may be out of the way, concealed, or securely locked, facilitating swift and hassle-free retrieval when required for a specific task and storage away from activities and potential damage (or theft) during non-use. Base 100 may be equipped with precision controls and sensor systems, which may make such an implement adept at autonomously identifying and selecting the appropriate modular attachment for the designated task. Through a coordinated process, base 100 may efficiently engage with modular lifting platform 200 (or any other modular attachment), securely affixing it to its framework. This integration exemplifies the system of the disclosure's capacity to optimize workflow and enhance operational efficiency, enabling a dynamic and responsive approach to diverse task requirements within the work site or warehouse setting. Further exemplary components, features, and benefits of modular lifting platform 200 in combination with base 100 may be further understood to those having ordinary skill in the art upon review of the remaining Drawings and Detailed Description.

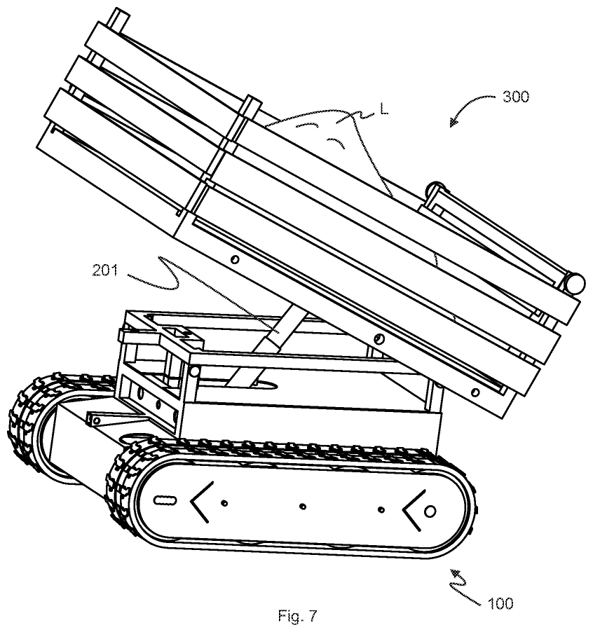

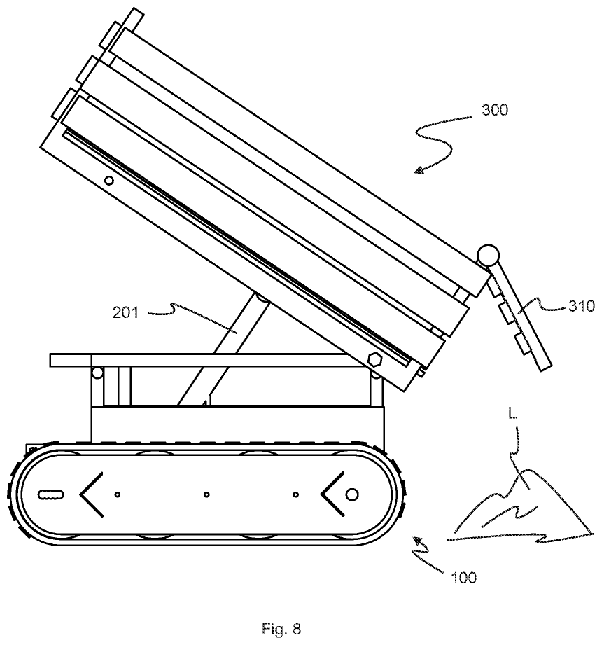

Turning to FIG. 6, illustrated therein is a perspective drawing of base 100 in combination with modular carrier 300 installed to modular lifting platform 200 having payload L in a carrying position. As illustrated herein FIG. 6, various systems and modular machines of the disclosure may generally feature base 100, which may generally include right tread 111 opposite left tread 112 for propelling base 100 forward and backward. Modular carrier 300 may combine with modular lifting platform 200 through various means, mechanisms, and methods as may be herein described above or modular carrier 300 may form an intricate assembly therewith either or both of modular lifting platform 200 and/or base 100 as may be alternatively herein described. Turning to the features of modular carrier 300 as may be apparent in FIG. 6, one having ordinary skill in the art may appreciate that modular carrier 300 may reside atop base 100 (and/or modular lifting platform 200) and be carried thereby base 100 to various areas as may be necessary for such a conveyance. Modular carrier 300 may feature a plurality of sides or a bordering wall to form an open-sided or open-top container. The sides or bordering wall of modular carrier 300 may be formed as herein illustrated having slats to form a fence, similar to a wagon or other conveying implement. In certain preferred embodiments, modular carrier 300 may feature gate 310 on an at least one side, which may correspond to the side opposite that which may be raised (see FIGS. 7-8). In such a configuration as may be apparent from FIG. 6, the wall and gate 310 combination may form an open-sided container, having a top side, which may be permanently open for deposit of, for example, payload L, as therein illustrated. Modular carrier 300 may receive payload L at one area, move to another area, and deposit payload L to the subsequent area (see FIG. 8). Those having ordinary skill in the art may appreciate the overall vertical weight distribution formed thereof base 100, modular lifting platform 200, and modular carrier 300. Such weight distribution may contribute to overall stability during translocation and especially during a turn of base 100 having payload L. Even an especially heavy or tall payload L may be capable of being stably traversed, thanks to the overall low center of gravity of the unloaded base 100/modular lifting platform 200/modular carrier 300, the slatted construction of the latter being potentially critically important to this consideration. However, the disclosure is not so limited to this slatted arrangement and may further include solid constructions, closing tops, and alternative hinged or otherwise-opened openings. Other adjustments may be contemplated by those having ordinary skill in the art and may be included to further enhance the utility of modular carrier 300 and its corresponding connections to modular lifting platform 200 and/or base 100. A further description of these and other considerations may be found in relation to FIGS. 7-8, which include illustrations of modular carrier 300 during steps of its exemplary payload L transportation task.

Turning now to FIGS. 7-8, which are described herein in combination, illustrated therein are a perspective drawing of base 100 in combination with modular carrier 300 in a depositing position. As illustrated herein FIGS. 7-8 and more thoroughly described in connection with FIG. 6, modular carrier 300 may generally feature connections to either of base 100 and modular lifting platform 200 for a platform having a vertical surround to form a container for payload L. It may further feature gate 310, which as illustrated herein FIGS. 7-8, may appear opposite the side lifted by lifting arm 201. Gate 310 may be hinged atop modular carrier 300 such that an opening of gate 310 may occur thanks to gravity alone, in that gate 310 may swing freely during a tilt as shown in FIG. 8. Alternatively, gate 310 may latch and/or lock in a closed position and may be opened through an actuator (electronic locking mechanism), a key, a lever, or any other means of opening gate 310 after closing gate 310 in such arrangements and mechanisms as may be known to those having ordinary skill in the art. Mechanisms for opening modular carrier 300 may include alternative means than gate 310 as may additionally be known to those having ordinary skill in the art. When opened, gate 310 may allow deposit of payload L through the egress there formed and such deposit may further proceed through gravity alone, such as when a dump truck lifts one end to deposit such payload. Alternative means for depositing payload L may include shoveling, scooping, vacuuming, sweeping, pushing, the like, and/or combinations thereof. Upon deposit of payload L, base 100 may then be free to perform a variety of other tasks as may be herein described.

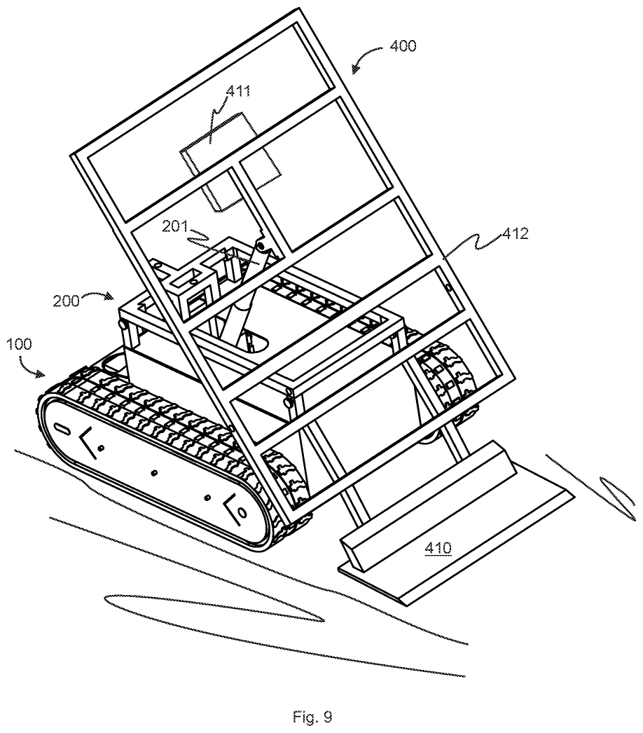

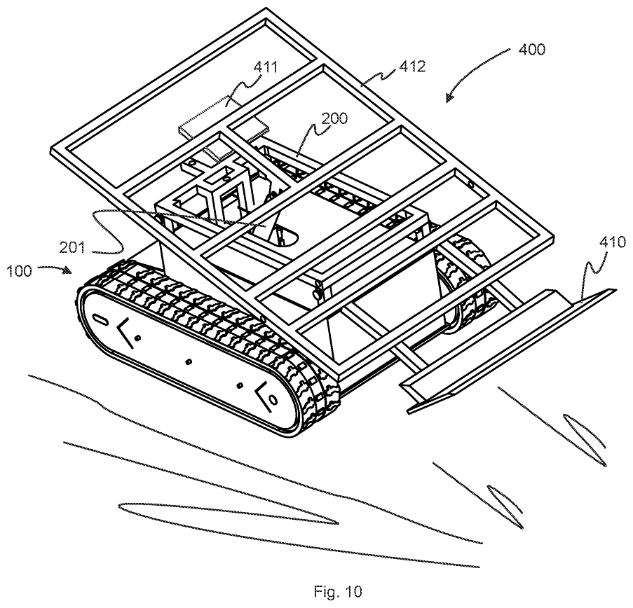

Now turning to FIGS. 9-10, which are described herein in combination, illustrated therein are a perspective drawings of base 100 in combination with modular hand truck attachment 400 in a lifting position and a conveying position. As illustrated herein FIG. 9, modular hand truck attachment 400 may generally feature dolly frame 412, dolly nose 410, and a connection to lifting arm 201, e.g., top rotational joint 204 (see FIG. 3). Modular hand truck attachment 400 may include those features and components of modular lifting platform 200 as are illustrated and described above and form a modular attachment to base 100 when so constructed or modular hand truck attachment 400 may be a modular attachment accessory thereof modular lifting platform 200 and connect thereto. A hinged connection may exist there between modular hand truck attachment 400 and base 100 and/or modular lifting platform 200 and base 100 such that modular hand truck attachment 400 is rotated about such hinge when lifting arm 201 is actuated, thereby tilting dolly nose 410 toward the ground during an extension of lifting arm 201 and tilting dolly nose 410 upwardly during a contraction of lifting arm 201. A potentially critically important feature of modular hand truck attachment 400, which may be included in certain embodiments of the systems of the disclosure, may be counterweight 411. Counterweight 411 may be important to the ability of base 100 to remain in contact with a floor or ground during a lifting of modular hand truck attachment 400 when lifting a particularly heavy payload L. Counterweight 411 may reside on the bottom of dolly frame 412 to accommodate and not interfere with consistent contact of payload L and dolly frame 412. It further may be located distally from dolly nose 410 to counterbalance downward gravitational force provided by payload L. Additional features of modular hand truck attachment 400 may include attachment points for straps and other securing devices, which may be present on modular hand truck attachment 400 as illustrated via bungee-type connections to dolly frame 412, in order to further secure payload L to modular hand truck attachment 400. In use, base 100 having connected thereto modular lifting platform 200 and/or modular hand truck attachment 400 may approach a payload needing transport, lower dolly nose 410 via an extension of lifting arm 201, place dolly nose 410 beneath the payload by moving base 100 toward it, then contract lifting arm 201 into connection cavity 122 (raising the payload and counterbalancing via counterweight 411), and transporting the payload via the locomotion mechanics as herein described. Having described base 100 and its various exemplary modular attachments, further possible attachments, mechanisms, and uses of base 100 may be further understood from the concluding Detailed Description and related Drawings.

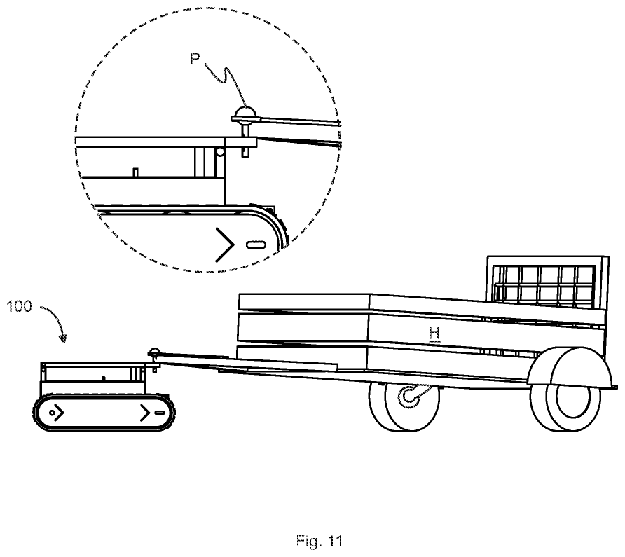

As it may relate to FIG. 11, illustrated therein is a perspective drawing of base 100 in a towing configuration with trailer H. Trailer H may be any automotive, industrial, military, and/or recreational trailer featuring any standard or non-standard mechanism for attachment to a primary conveyance/vehicle and the features, parts, and components thereof may be important to the versatility and/or interoperability of base 100 in relation to various manufactured trailers. Though trailer H may be illustrated to include two wheels and an open-topped container/fence, the description is not so limited and may further include, but not limited to, travel trailers, dump trailers, flatbed trailers, towing trailers, enclosed trailers, boat trailers, campers, the like and/or combinations thereof. Additionally, such a trailer may feature one, many, or no wheels. For instance, as may be appreciated by those having ordinary skill in the art, countless innovations in vehicle hitch accessories have been achieved in recent decades, many of which may be compatible with base 100, modular lifting platform 200, and other modular attachments and/or features of the system of the disclosure. By way of example and not limitation, these may include bike racks, cargo carriers, hitch accessory mounts, hitch seating, the like, and/or combinations thereof as well as implements and devices which may later be conceived to be compatible with a standard vehicle hitch (which may include standard sizes and adapters thereof). Finally, in such an embodiment of the combination of base 100, modular lifting platform 200, and trailer H, hitch pin P may be optionally included in order to temporarily secure trailer H to the system formed thereof.

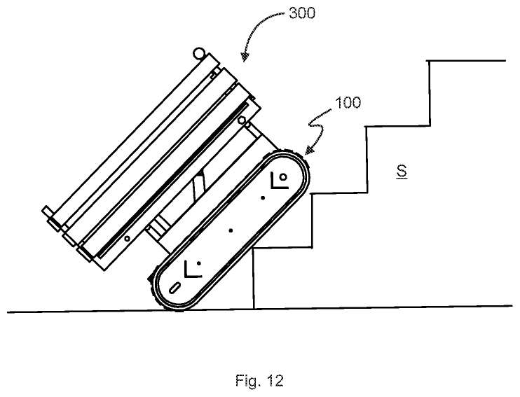

Turning to FIG. 12, illustrated therein is an elevation drawing of base 100 in combination with modular carrier 300 climbing stairs S. As illustrated therein FIG. 12 and more thoroughly illustrated and/or described in relation to FIGS. 1-2 and FIGS. 6-8, base 100 may generally feature right tread 111 and left tread 112 and modular carrier 300 may feature a container formed from a plurality of slats and a platform and having gate 310. As illustrated herein FIG. 12, lifting arm 201 may be a component of modular carrier 300 and/or modular lifting platform 200, and is illustrated in the down/contracted/carrying position, which may be optimal when performing a task such as climbing stairs. Perhaps importantly, right tread 111 and left tread 112 may optimally be aligned with an approach of stairs S perpendicular to the treads. Such treads may be optimally manufactured from a material having a highly rubberized surface to maximize friction between treads 111, 112 and stairs S. In use, base 100 of the disclosure having various modular attachments as herein disclosed is capable of stably and safely climbing various types of staircases, such as stairs S, absent further improvements beyond what has been described above. However, certain additional improvements and/or modifications to base 100 may further enhance this capability. For example, as it approaches staircase S, base 100's sensors and algorithms may analyze the steps' configuration. The specialized continuous track system having treads 111, 112 may then engage, adjusting the treads' position to align with the stairs upon approach. Additionally, treads 111, 112 may be equipped with specialized features for gripping and extension, or when making initial contact with the leading edge of stairs S or any individual step thereof. Then, as base 100 starts ascending, treads 111, 112 may systematically adjust, lifting themselves off the ground and placing onto the next step. This motion may be coordinated and continue throughout the climb, ensuring a seamless transition from one step to the next. During a climb, base 100 may utilize a combination of sensors and control algorithms to maintain stability throughout the climb. These sensors constantly monitor the base's inclination and orientation, making real-time adjustments to the tread positions or real time adjustments to the balance of payload L in modular carrier 300 by, for example, extending and retracting lifting arm 201 to achieve a level platform thereof modular carrier 300 during climb. Strategically positioned sensors which may detect any potential obstructions or irregularities on the staircase or those capable of detecting and/or mapping surface conditions (i.e., slick, carpeted, etc.), enabling base 100 to adapt its movements accordingly when approaching and/or completing a climb. By synchronizing these complex mechanical motions with sophisticated sensor feedback and control algorithms, base 100 may more adeptly navigate stairs S with even greater precision and stability. This stair-climbing capability significantly broadens the range of environments in which base 100 can operate, showcasing its versatility in tackling complex terrains and obstacles. Whether in warehouses, homes, or other settings, base 100's ability to negotiate stairs introduces new possibilities for its application across diverse industries and operational scenarios.

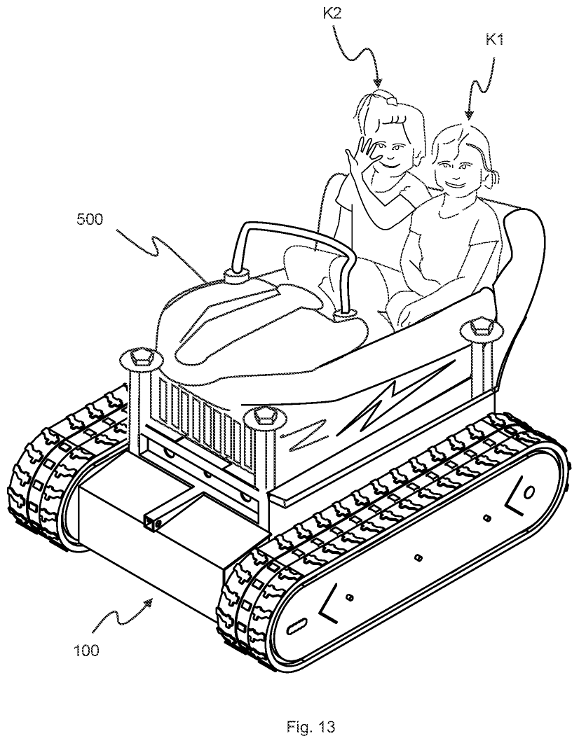

Turning now to FIG. 13, illustrated therein is a perspective drawing of base 100 in combination modular recreational vehicle body 500. As illustrated therein FIG. 13 and more thoroughly illustrated and/or described in relation to FIGS. 1-2, base 100 may generally feature treads 111, 112 as well as other mechanical features which may enable forward/reverse movement and combination with a plurality of modular attachments. As a display of the versatility and possibilities available in such a deployment of a modular system, mere recreation may be an important feature of the disclosure, and may enable, for example, children K1, K2 to enjoy a motorized ride upon base 100. Such implementations may include stylized or otherwise aesthetically pleasing or even “fun” designs that may attract and provide enjoyment for children. Any of the various features of such recreational vehicles may be employed in such constructions, and may further offer, e.g., towing capabilities to increase the number of children being entertained by such combinations. As has been described herein, such configurations may be directly controlled using onboard interfaces, remotely controlled using remote interface devices, or automated in connection with an automation system. Additional business and/or productive uses of the system as disclosed herein may further include heat and air conditioning installations (i.e., providing a haul-away of existing systems and conveyance of new system as well as general conveyance of heavy systems), appliance delivery and installation, landscaping, automotive mechanics, hazardous waste disposal and/or containment, bomb/ordinant investigation and/or retrieval, tree removal, building material conveyance, or any other carrying of heavy and/or bulky items as may be known to those having ordinary skill in the art. While a focus of this disclosure may be upon various industrial and/or heavy machine tasks in order to provide a versatile system for use in such tasks, the description also includes more frivolous and/or domestic uses, which may include but are not limited to use as a beach wagon, transportation of sportsman gear (e.g., fishing, hunting), residential yard maintenance, transportation of consumables at special events (e.g., food, ice, beverages), outdoor living (i.e., camping), sporting events, or other simple conveyance tasks that may utilize some combination of base 100 and other modular attachments.

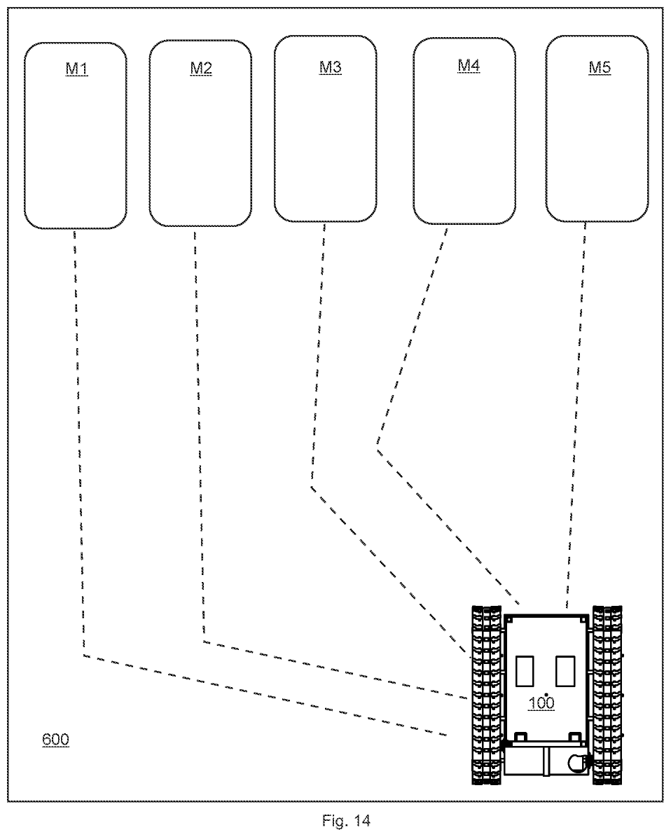

As it may relate to FIG. 14, illustrated therein is a top plan drawing of facility 60 having an exemplary embodiment of the system of the disclosure. One having ordinary skill in the art may consider FIG. 14 as a culmination of FIGS. 1-13 and understanding thereof may rely and/or be dependent on the thorough understanding of each previous Drawing. In other words, in FIG. 14, the comprehensive system of the disclosure comes to life, showcasing base 100 positioned at the bottom right corner, while an array of modular attachments M1-M5 line the top section of the rectangular border, which represents facility 600, which may be any building, job site, or other terrain upon which base 100 and the systems and machines of the disclosure may be deployed. Such a deployment may be considered a strategically organized workspace therein facility 600. Dotted lines linking base 100 to each of modular attachments M1-M5 illustrate potential paths base 100 may take during the following procedure. Base 100 may autonomously or remotely navigate facility 600, intelligently selecting the most suitable of modular attachments M1-M5 for a designated task. Through a sophisticated combination of sensors, algorithms, and/or remote control interfaces, base 100 or a user thereof can efficiently identify and approach the desired attachment, ensuring a precise and secure connection. Automated systems proximate modular attachments M1-M5 may connect one or more of modular attachments M1-M5 to base 100 for use thereby. Once engaged with the chosen modular attachment, base 100's highly adaptable mechanics and controls may further facilitate the seamless execution of the designated task. Whether it involves the lifting and transportation capabilities of modular hand truck attachment 400 or various heavy machinery tasks which may be assembled into another modular attachment base 100 may orchestrate the task with precision and efficiency. Upon task completion, base 100 may disengage the modular attachment, readying itself for the next assignment. With calculated movements, it may safely return the attachment to its designated storage location, ensuring the workspace remains uncluttered and organized. This meticulous process may ensure that the correct attachment is stowed securely, readily accessible for future tasks. Then, the system's versatility may further be observed as base 100 can then autonomously or remotely identify and retrieve the next required modular attachment for the subsequent task. This seamless cycle of attachment selection, task execution, detachment, and replacement underscores the system's adaptability and efficiency, offering a dynamic and responsive approach to a wide range of tasks, all orchestrated by the capable and adaptable base 100 and the modular attachments as described and illustrated herein.

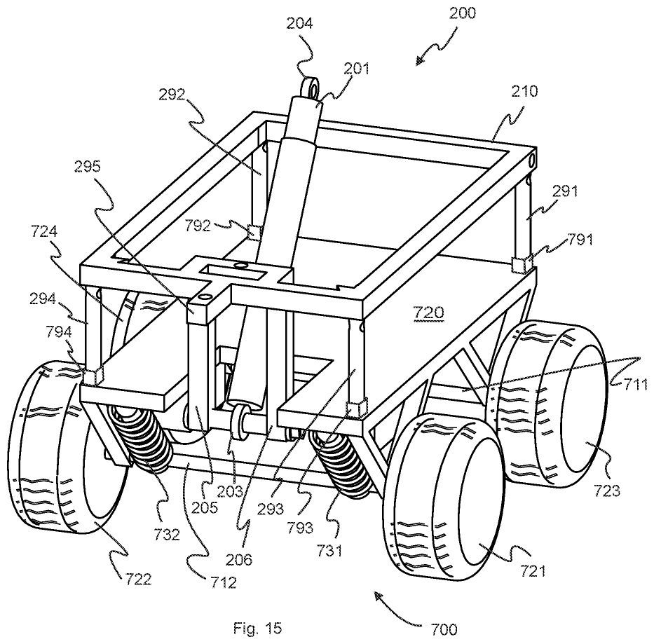

With respect to FIG. 15, illustrated therein is a perspective drawing of alternate base 700 in combination with modular lifting platform 200. As it may be important to alternate base 700, modular lifting platform 200 and other various modular accessories of the disclosure, may feature lifting platform connection posts 291-294 (including, e.g., right front lifting platform connection post 291, left front lifting platform connection post 292, right rear lifting platform connection post 293, and left rear lifting platform connection post 294), which may correspond and operably combine with alternate base connection posts 791-794 as illustrated herein FIG. 15. As illustrated in FIG. 4, modular lifting platform 200 may generally comprise a plurality of members spanning from each of the 4 corners formed by lifting platform connection posts 291-294. Such members may be understood to form platform 210 extending downward from platform 210 from one such member may be sub-platform extensions 205-206, which may be configured to extend into a cavity of alternate base platform 720. Finally, with respect to modular lifting platform 200, it may further feature the parts of lifting arm 201 with bottom rotational joint 203 and top rotational joint 204 for connection between sub-platform extensions 205-206 and another modular attachment of the disclosure, and platform hitch 295. Alternate base 700 may be in contact with the ground via wheel/tire assemblies 721-724 to achieve a relatively stable means for conveyance. Wheel/tire assemblies 721-724 may be paired via front axel 712 and rear axel 711. Such tire/wheel/axel assemblies may feature suspension systems, such as left shock 731 and right shock 732 and be powered by a motor which causes either the front or rear axel to spin, thereby causing the wheel pair to propel alternate base 700. A steering means may be further provided to turn either or both of the wheel pairs. As may be understood by those having skill in the art, such alternate base 700 may be used in combination with the modular attachments of the disclosure and embody an alternative which may be less expensive to produce and may be manufactured to achieve a lighter overall weight. Benefits of adoption alternate base 700 in systems featuring base 100 and/or lacking base 100 may be numerous and may significantly improve the overall versatility of the system of the disclosure when adopted in conjunction. By way of example and not limitation, certain uses of alternate base 700 may be best understood by the potential modular attachments thereof which may include beach wagons, beverage carts, coolers, refrigerators, freezers, modular grills and other cooking appliances, toolboxes, seating, the like, and/or combinations thereof. Finally, with respect to alternate base 700, it may further include means for connecting to, pulling, pushing, being pulled, being pushed, the like and/or combinations thereof via a hitch or operable connection, which may be capable of controlling the steering, speed, and other movement via mechanical and/or electronic interactions between the various modular bases, or various non-modular base conveyances, such as trailers.

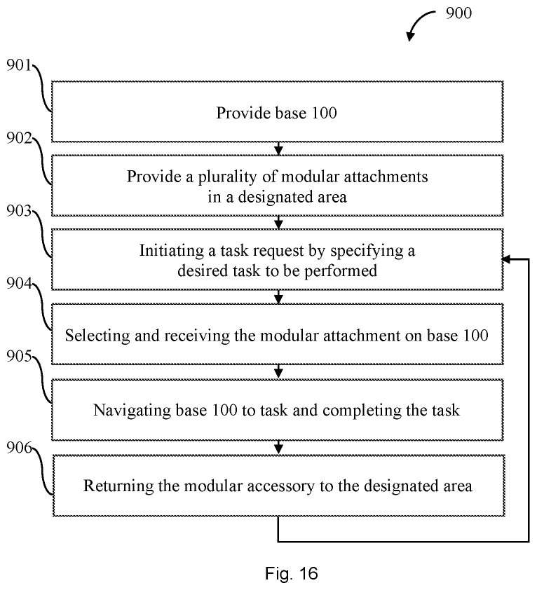

Turning now to FIG. 16, illustrated therein is a flowchart drawing of method 900 of the disclosure. Importantly, method 900 may occur in a variety of environments, buildings, terrains, etc., thanks to the versatility of base 100 as is herein described. Tasks, as they may be understood by those having ordinary skill in the art may be any task which a modular accessory of the disclosure may accomplish, based on the corresponding features of base 100 in such combination. First, at step 901, base 100 may be provided. Then, at step 902, a plurality of modular attachments may be positioned, stored, or otherwise staged in a designated area. A task request may be then initiated at step 903, which may include a plurality of tasks, and may be received by base 100 via the computerized systems as are herein described or an operator having remote control of base 100. Based on the task request, the appropriate modular accessory is selected and attached to base 100 to form a combination thereof at step 904. Base 100 may then navigate to the area where the specified task is to occur and complete the task according to the disclosure herein at step 905. Finally, in at least an initial stage of method 900 of the disclosure, at step 906 base 100 in combination with the modular attachment may return to the designated area in order to detach and return the modular attachment to the designated area, which may cause method 900 to repeat steps 903-906 as illustrated therein FIG. 15.

With respect to the above description then, it is to be realized that the optimum dimensional relationships, to include variations in size, materials, shape, form, position, function and manner of operation, assembly, type and structure of materials, shape, manner of assembly, and type of vehicle and use, are intended to be encompassed by the present disclosure.

It is contemplated herein, and should be realized by those having ordinary skill in the art, that the system of the disclosure (and its methods of use) includes variations in size, shape, construction, manufacture, components, power source, assembly, the like and/or combinations thereof. As contemplated herein, the system of the disclosure as well as the various devices and machines may be powered using onboard vehicle power, or may be powered internally through use of any known method of powering a device of the disclosure. While specific dimensions, shapes, angles, components, gears, engines, bolts, pins, motors, treads, the like and/or combinations thereof of the disclosed system may be specifically described herein, the disclosure is not so limited. The system of the disclosure may include one or more of the modular attachments as herein described and may additionally (or alternatively) include other modular attachments configured to be received and controlled by base 100 to complete various other tasks as may be understood by those having ordinary skill in the art. Such system may be a comprehensive multi-task machinery solution having comprehensive features and numerous corresponding modular attachments or may feature base 100 and one or more optional modular attachments that can be customized for specific needs. While the machine may be used to lift various objects and payloads disclosed herein, other uses of the machine may be understood by those skilled in the art and the disclosure is not so limited to include only the disclosed uses. It should also be noted that various mechanisms, parts, attachments, and accessories may be appended to base 100 or the modular attachments thereof the disclosed system to provide additional features and benefits. Such features may include mopping, sweeping, washing, waxing/polishing, metal collection (via magnets and/or electromagnets), directed spray (e.g., pesticides/herbicides), heating/cooling systems, fans, geolocation (via GPS systems), the like and/or combinations thereof.

The foregoing description and drawings comprise illustrative embodiments of the present disclosure. Having thus described exemplary embodiments of the system, it should be noted by those ordinarily skilled in the art that the within disclosures are exemplary only, and that various other alternatives, adaptations, and modifications of the system may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. A modular vehicle system comprising:
a base vehicle having a right continuous track and a left continuous track forming a track pair, each of said track pair powered by a first and second independent motor from an independent motor pair, said independent motor pair controlled by a controller;
a plurality of modular attachments capable of operably combining with said base vehicle; and
a connection mechanism therebetween said base vehicle and each of said plurality of modular attachments.

2. The system of claim 1, wherein said base vehicle further comprises a first, a second, a third, and a fourth mounting location to receive an at least one of said plurality of modular accessories.

3. The system of claim 2, wherein said base vehicle further comprises a control connection to said at least one of said plurality of modular attachments, said control connection is capable of controlling a movement of said at least one of said plurality of modular attachments.

4. The system of claim 3, wherein said base vehicle further comprises a body surrounding said independent motor pair and an at least one battery having a connection thereto.

5. The system of claim 4, wherein said body has an opening, said opening is configured to receive a lifting arm of said at least one of said plurality of modular attachments.

6. The system of claim 5, wherein said at least one of said plurality of attachments comprises said lifting arm having a connection to a span member connecting an elongated member pair having an upper end and a lower end, said lower end having a wedge configured to contact a ground when said lifting arm is in a raised position.

7. The system of claim 5, wherein said at least one of said plurality of attachments comprises said lifting arm having a connection to a base of a container, said base configured having a surface substantially parallel with said track pair when said lifting arm is in a lowered position.

8. The system of claim 7, wherein said container further comprises a plurality of sides, at least one of said plurality of sides is configured to open when said lifting arm is in a raised position.

9. The system of claim 5, wherein said controller is capable of receiving a broadcast from a wireless remote control.

10. The system of claim 5, wherein said controller is a computing device having a processor, a memory, a non-transitory computer readable medium, a network connection, and an at least one sensor.

11. The system of claim 10, further comprising:
a task input interface for receiving an input specifying a plurality of tasks to be performed;
a task scheduler module for storing said plurality of tasks in said memory of said controller, prioritizing and scheduling said plurality of tasks based on a sensor data from said sensor and an external information accessed through said network connection;
an automated execution module configured to initiate a selection, a connection, and an execution of each of said plurality of tasks according to a prioritization schedule.

12. A method for operating a modular vehicle system, comprising the steps of:
providing a base vehicle comprising a right continuous track and a left continuous track, forming a track pair, each track pair independently powered by a first and second motor from an independent motor pair, the operation of said motor pair being overseen by a controller;
providing a plurality of modular attachments in an at least one designated area;
initiating a task request by specifying a desired task to be performed;
selecting a first modular attachment from said plurality of modular attachments, the modular attachment capable of performing said desired task;
utilizing said controller to navigate said base vehicle to approach said modular attachment;
connecting said modular attachment to said base vehicle; and
executing said specified task using said modular attachment under the control of said controller.

13. The method of claim 12, further comprising a step of utilizing said controller to navigate a combination of said base vehicle and said modular attachment combination to said designated area and a step of disengaging said modular attachment.

14. The method of claim 13, wherein said base vehicle further comprises a first, a second, a third, and a fourth mounting location to receive an at least one of said plurality of modular accessories.

15. The method of claim 12, wherein said base vehicle further comprises a body surrounding said independent motor pair and an at least one battery having a connection thereto.

16. The method of claim 15, wherein said body has an opening, said opening is configured to receive a lifting arm of an at least one of said plurality of modular attachments.

17. The method of claim 16, wherein said at least one of said plurality of attachments comprises said lifting arm having a connection to a span member connecting an elongated member pair having an upper end and a lower end, said lower end having a wedge configured to contact a ground when said lifting arm is in a raised position.

18. The method of claim 16, wherein said at least one of said plurality of attachments comprises said lifting arm having a connection to a base of a container, said base configured having a surface substantially parallel with said track pair when said lifting arm is in a lowered position.

19. The method of claim 12, wherein said controller is a computing device having a processor, a memory, a non-transitory computer readable medium, a network connection, and an at least one sensor.

20. The method of claim 19, further comprising:
receiving an input at said controller via said network connection, said input specifying a plurality of tasks to be performed;
storing said plurality of tasks in said memory of said controller;
utilizing said at least one sensor to assess an area relevant to said tasks plurality of tasks;
employing said network connection to access an external data source for an additional task-related information;
processing said input, a sensor data, and said additional task-related information to prioritize and schedule said plurality of tasks into a plurality of steps having a prioritization schedule;
initiating a selection of and a connection to an at least one of said plurality of modular attachments; and
executing said plurality of steps for said plurality of specified tasks in accordance with said prioritization schedule.
